(19) United States
(12) Patent Application Publication
(10) Pub. No.: US 2010/0066767 A1
(43) Pub. Date: Mar. 18, 2010

(54) LCOS INTEGRATED CIRCUIT AND ELECTRONIC DEVICE USING THE SAME

(75) Inventors: Hon-Yuan Leo, Tainan County (TW); Wei Hsiao Chen, Tainan County (TW); Cheng Chi Yen, Tainan County (TW); Yao Jen Tsai, Nantou County (TW)

Correspondence Address: J C PATENTS, 4 VENTURE, SUITE 250, IRVINE, CA, 92618, US

(73) Assignee: HIMAX DISPLAY, INC., Tainan County (TW)

(21) Appl. No.: 12/557,735

(22) Filed: Sep. 11, 2009

Related U.S. Application Data
(63) Continuation-in-part of application No. 11/319,339, filed on Dec. 27, 2005.

(51) Int. Cl. G09G 5/10

(52) U.S. Cl. 345/690

(57) ABSTRACT

A liquid crystal on silicon integrated circuit (LCOS IC) and electronic device using the same is provided. The electronic device comprises an LCOS IC, a processor and a cooler. The LCOS IC comprising a temperature sensor embedded in the LCOS IC for sensing a temperature and outputting a temperature sensing signal according to the temperature. The processor is coupled to the LCOS IC for receiving the temperature sensing signal and outputting a cooler control signal according to the temperature sensing signal. The cooler is coupled to the processor for receiving the cooler control signal and adjusting the cooler accordingly.

### CROSS-REFERENCE TO RELATED APPLICATION

This application is a continuation-in-part of and claims the priority benefit of an application Ser. No. 11/319,339, filed on Dec. 27, 2005, now pending. The entirety of the above-mentioned patent application is hereby incorporated by reference herein and made a part of this specification.

### BACKGROUND OF THE INVENTION

1. Field of Invention

The present invention relates to a liquid crystal on silicon (LCOS) integrated circuit. More particularly, the present invention relates to an LCOS integrated circuit having temperature sensor therein and an electronic device using the same.

2. Description of Related Art

A three-panel color video projection display system generally includes a separate reflective or transmissive LCD panel for each of the red, green and blue components, with the components being spatially separated such that each component is directed to its corresponding LCD panel. Each of the red, green and blue components is modulated in its corresponding panel by an applied red, green or blue signal generated from a video signal. As in the single panel system, the resulting modulated components are directed via a projection lens to a display screen for viewing of the video signal.

A particular type of reflective LCD panel known as a liquid crystal on silicon (LCOS) display panel uses reflective LCD elements arranged on a silicon backplane. LCOS display panels can be used in both single-panel and three-panel configurations, and are increasingly popular for use in applications such as compact projectors and head-up projection display systems. LCOS display panel has a number of significant advantages over other types of reflective LCD panels, for example, crystalline silicon can be used to form active matrix elements of the LCOS panels. The silicon backplane can also be used to form the TFT drivers and other functional circuitry, using well-known and efficient semiconductor manufacturing techniques.

FIG. 1 is a side view of a conventional LCOS projector. As shown in FIG. 1, LCOS integrated circuit (IC) 110 is mounted on one side of a heat sink 100, and liquid crystal (LC) 120 is arranged between a cover glass 130 and the LCOS IC 110. For dynamically adjusting R-V curve or gamma curve of the LC 120, a thermal couple 140 is mounted to another side of the heat sink 100 for measuring the nearby temperature. The measured result is sent to a controller to adjust rotation speed of fans for maintaining constant temperature or R-V curve of the LC 120. However, because of temperature gradient effect, it is difficult to measure temperature of the LC 120. Accordingly, the operations, such as adjusting rotation speed of fans or R-V curve of the LC 120, can not come to a precise compensation on display qualities.

### SUMMARY OF THE INVENTION

Accordingly, one of the objects of the invention is to provide a liquid crystal on silicon integrated circuit (LCOS IC) such that display variation caused by temperature can be compensated more precisely.

Another object of the invention is to provide an electronic device of which the production cost can be decreased while implementing LCOS IC therein.

To at least achieve the above and other objects, the invention provides an LCOS IC, which is characterized in including a temperature sensor embedded in the LCOS IC. The temperature sensor senses a temperature and outputs a corresponding temperature sensing signal. The temperature sensor includes a supply independent current circuit, a first diode, a first resistor, a second diode, and a second resistor. The supply independent current circuit provides first/second/third currents such that the first/second/third currents have same current value. The first diode is coupled between the supply independent current circuit and a predetermined voltage such that the first current flows through the first diode. One end of the first resistor is coupled to the supply independent current circuit for receiving the second current. The second diode is coupled between another end of the first resistor and the predetermined voltage such that the second current flows through the second diode. The second resistor is coupled between the supply independent current circuit and the predetermined voltage, and receives the third current. The temperature sensing signal is generated at a point on a conducting path for coupling the supply independent current circuit and the second resistor. The first diode and the second diode are substantially different in size.

In an embodiment of the invention, the temperature sensor is set at a position adjacent to a liquid crystal layer.

In an embodiment of the invention, the temperature sensor is set at a position under a liquid crystal layer.

The invention further provides an electronic device which includes a temperature sensor mentioned above and a processor. The temperature sensor is embedded in a liquid crystal display for sensing a temperature and outputting a temperature sensing signal according to the temperature. The processor is coupled to the liquid crystal display for receiving the temperature sensing signal and outputting a cooler control signal according to the temperature sensing signal. The cooler is coupled to the processor for receiving the cooler control signal and adjusting the cooler accordingly.

In an embodiment of the invention, the processor further outputs a gamma control signal to the liquid crystal display for adjusting a gamma curve of a liquid crystal of the electronic device.

In an embodiment of the invention, the processor further adjusts an R-V curve of a liquid crystal according to the received temperature sensing signal.

In an embodiment of the invention, the temperature sensor is set at a position adjacent to a liquid crystal layer.

In an embodiment of the invention, the temperature sensor is set at a position under a liquid crystal layer.

In an embodiment of the invention, the electronic device further includes a cooler coupled to the processor for receiving the cooler control signal and adjusting the cooler according to the cooler control signal.

The invention further provides a temperature sensor mentioned above for sensing a temperature and outputting a temperature sensing signal according to the temperature.

Accordingly, the present invention provides a temperature sensor for sensing a temperature and outputting a temperature sensing signal according to the temperature. The temperature sensor can be embedded in the LCOS IC such that temperature can be more precisely sensed because the temperature sensor is much more near the liquid crystal. Further, the production cost can be reduced because no extra thermal couple should be mounted on the heat sink as prior art did.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a conventional LCOS projector.

FIG. 2 is a side view of an electronic device using the LCOS IC according to one embodiment of the present invention.

FIG. 3 is a circuit block diagram of an electronic device using the LCOS IC according to one embodiment of the present invention.

FIG. 4 is a circuit diagram of a temperature sensor according to one embodiment of the present invention.

FIG. 5 is a circuit diagram of a temperature sensor according to another embodiment of the present invention.

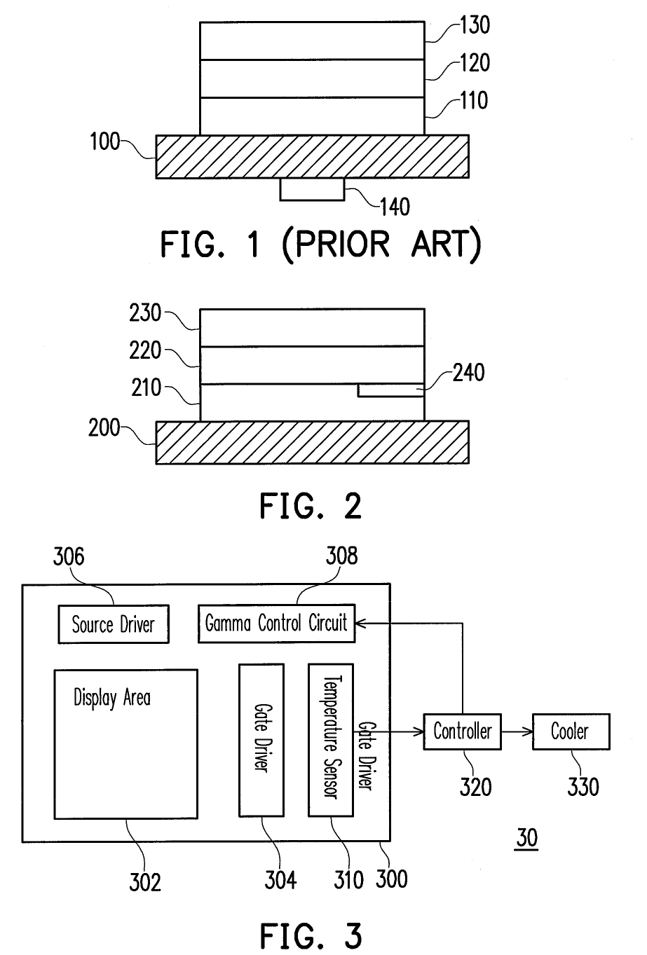

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It is known that display quality of a liquid crystal (LC), comprising rising time, falling time and twisted angle, can be affected by operation temperature. Therefore, compensation on temperature variation is necessary for those display device the uses LC as a display medium, such as a liquid crystal on silicon (LCOS) projector.

For LCOS display devices, an LCOS integrated circuit (IC) should be embedded therein. FIG. 2 is a side view of an electronic device using a LCOS integrated circuit (IC) according to one embodiment of the present invention. In the embodiment, a LCOS IC 210 is mounted on a heat sink 200, and a liquid crystal (LC) 220 is arranged between a cover glass 230 and the LCOS IC 210. Particularly, a temperature sensor 240 is embedded in the LCOS IC 210 for sensing a temperature near the LC 220. Furthermore, the temperature sensor 240 is better set at a position near or adjacent to the liquid crystal. The position, which the temperature sensor 240 is set, may be a position under the LC.

For more detailed description, please refer to FIG. 3. FIG. 3 is a circuit block diagram of an electronic device using the LCOS IC according to one embodiment of the present invention. In the embodiment, the electronic device 30 comprises an LCOS IC 300, a controller 320 and a cooler 330. The LCOS IC 300 comprises a display area 302, a gate driver 304, a source driver 306, a gamma control circuit 308, and, particularly, a temperature sensor 310. Operation relationships between display area 302, gate driver 304, source driver 306 and gamma control circuit 308 are well-known by those skilled in the art and therefore they are not explained in the specification. Moreover, it should be noted that the positions of the function blocks, including display area 302, source driver 306, gamma control circuit 308 and temperature sensor 310, are not limited to what shown in FIG. 3.

In the embodiment, temperature sensor 310 senses temperature nearby and outputs a corresponding temperature sensing signal to the controller 320. Because a precision temperature parameter is helpful for making compensation on display quality variation caused by temperature variation, the temperature sensor 310 is better set at a position near or adjacent to the liquid crystal (LC), which is used for operating in the display area 302, such that the temperature sensor 310 may precisely sense the temperature of the LC accordingly. The position, which the temperature sensor 310 is set, may be a position under the LC.

After receiving the temperature sensing signal outputted from the temperature sensor 310, the controller 320 tries to compensate display quality variation caused by temperature variation. As shown in FIG. 3, the controller 320 may output a cooler control signal to the cooler 330 such that the cooler 330 can adjust itself according to the cooler control signal.

In another way, the controller 320 may output a gamma control signal to the gamma control circuit 308 in the LCOS IC 300 for adjusting a gamma curve of the LC of the electronic device 30.

In still another way, the controller 320 may adjust an R-V curve of the LC used for operating in the display area 302 according to the received temperature sensing signal.

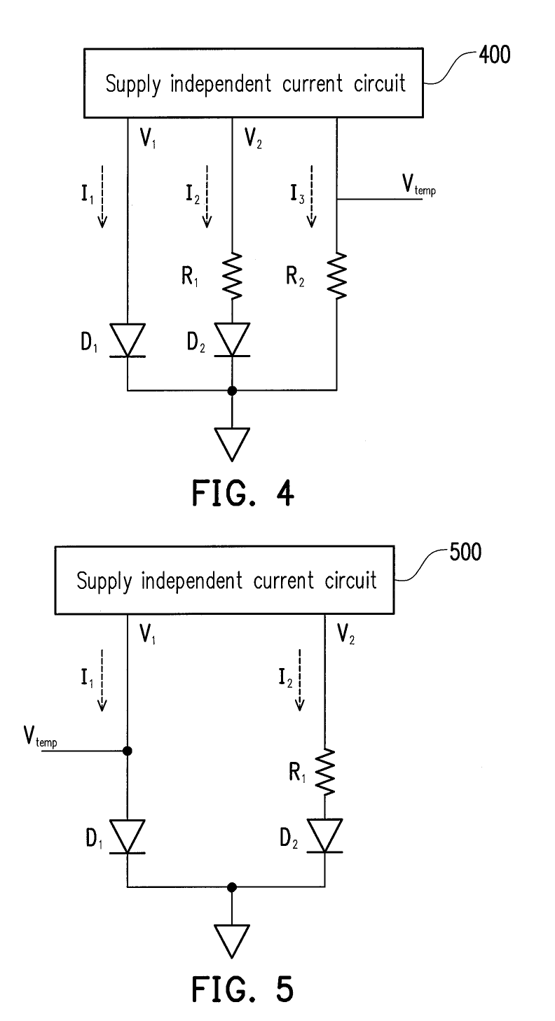

Refer to FIG. 4, which is a circuit diagram of a temperature sensor according to one embodiment of the present invention. In the embodiment, the temperature sensor comprises a supply independent current circuit 400, resistors R1 and R2, and diodes D1 and D2. The diodes D1 and D2 can be simple p-n junction diodes of two terminal devices or diode-connected transistors. Each of the diodes D1 and D2 has negative temperature coefficient, so the voltage drop across the diode depends on temperature. In addition, the diodes D1 and D2 are substantially different in size in the present embodiment of the invention. A detailed description of the circuit operation will be provided in the following paragraph. The supply independent current circuit 400 provides three currents I1, I2 and I3, and the three currents have the same current value. Furthermore, voltages V1 and V2 are the same. Diode D1 is coupled between the supply independent current circuit 400 and ground for receiving current I1. Resistor R1 and diode D2 are serially connected to each other and coupled between the supply independent current circuit 400 and ground for receiving current I2. Resistor R2 is coupled between the supply independent current circuit 400 and ground for receiving current I3.

For the situation that voltage V1 equals to voltage V2 and currents I1, I2 and I3 have the same current value, a temperature sensing signal Vtemp can be obtained from a point on the conducting path between resistor R2 and the supply independent current circuit 400.

Refer to FIG. 5, which is a circuit diagram of a temperature sensor according to another embodiment of the present invention. In the embodiment, the temperature sensor comprises a supply independent current circuit 500, resistor R1, and diodes D1 and D2. The supply independent current circuit 400 provides two currents I1 and I2, and the two currents have the same current value. Diode D1 is coupled between the supply independent current circuit 500 and ground for receiving current I1. Resistor R1 and diode D2 are serially connected to each other and coupled between the supply independent current circuit 500 and ground for receiving current I2. For the situation that currents I1 and I2 have the same current value, a temperature sensing signal Vtemp can be obtained from a point on the conducting path between diode D1 and the supply independent current circuit 500.

In detail, referring to both FIGS. 4 and 5, when the currents I1, I2 and I3 are constant currents, a voltage between two ends of the resistor R2 and a voltage between two ends of the diode D1 are related to the temperature variation. For example, the voltage between two ends of the resistor R2, symbolized by Vr, has a positive temperature coefficient, e.g. dVr/dT=2 mV/C, wherein T represents absolute temperature. The voltage between two ends of the diode D1, symbolized by Vd, has a negative temperature coefficient, e.g. dVd/dT=−1.6 mV/C. Therefore the temperature sensing signal Vtemp is generated as the absolute temperature changes.

Currents passing through diodes are related to nearby temperatures. As described before, the diode D1 and D2 are substantially different in size. If a ratio between an area of diode D1 and an area of diode D2 is K, the currents passing through the diode D1 and the diode D2 are respectively I1=I_{S}×ê(V_{D1}/nV_{T}) and I2=K×I_{S}×ê(V_{D2}/nV_{T}), wherein V_{T} is a thermal voltage, and I_{S} is a reverse saturation current of the diode. The thermal voltage V_{T} denotes the relationship between the flow of electrical current and the electrostatic potential across a p-n junction. The thermal voltage V_{T}=k×T/q, where k is Boltzman's constant, T is an absolute temperature, and q is a number of electron charges. Hence, the voltages V_{D1} and V_{D2} respectively on the diodes D1 and D2 are able to be deduced from the currents I1 and I2 passing through the diodes D1 and D2, namely, by using the formulae V_{D1}=n×V_{T}×ln(I1/I_{S}) and V_{D2}=n×V_{T}×ln(I2/KI_{S}), wherein V_{D1}=V1 in the embodiment. In a situation where V1=V2, a voltage V_{RI} on the resistor R1 is: V_{R1}=I2×R1=V1−V_{D2}=V_{D1}−V_{D2}=n×V_{T}×ln((I1/I_{S})×(KI_{S}/I2)). Since the supply independent current circuit 400 provides the equal currents I1, I2 and I3, the voltage V_{R1} on the resistor R1 is: V_{R1}=I2×R1=n×V_{T}×ln(K), and I2=n×V_{T}×ln(K)/R1. By appropriately designing a ratio between R1 and R2, for e×ample R2=M×R1, the temperature sensing signal Vtemp=I3×R2=(n×V_{T}×ln(K)/R1)×M×R1=n×V_{T}×M×ln(K), where n, M and K are parameters unrelated to the temperature. Since the thermal voltage V_{T} changes with temperature variation, the temperature sensing signal Vtemp also changes with temperature variation.

Specifically, for e×ample, by partial differentiation of the absolute temperature T with the thermal voltage V_{T}, it may be obtained that each centigrade degree generates a 0.085 millivolt change in the thermal voltage V_{T}. In addition, by calculating the partial derivative of the function Vtemp=n×V_{T}×M×ln(K) with respect to the absolute temperature T, sensitivity of the temperature sensing signal Vtemp to change in the absolute temperature T may is also obtained.

Accordingly, the present invention provides an LCOS IC with a temperature sensor embedded therein and an electronic device using the same such that the production cost can be reduced because thermal couple mounted on the heat sink is no more needed. Further, the compensation made for temperature variation can be more precise because temperature detection is performed at nearby of the LC.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A liquid crystal on silicon (LCOS) integrated circuit, which is characterized in comprising a temperature sensor embedded in the liquid crystal on silicon integrated circuit, wherein the temperature sensor senses a temperature and outputs a corresponding temperature sensing signal, the temperature sensor comprising:
a supply independent current circuit, providing first/second/third currents such that the first/second/third currents have same current value;
a first diode, coupled between the supply independent current circuit and a predetermined voltage such that the first current flows through the first diode;
a first resistor, one end of the first resistor coupled to the supply independent current circuit for receiving the second current;
a second diode, coupled between another end of the first resistor and the predetermined voltage such that the second current flows through the second diode; and
a second resistor, coupled between the supply independent current circuit and the predetermined voltage for receiving the third current, wherein the temperature sensing signal is generated at a point on a conducting path for coupling the supply independent current circuit and the second resistor,
wherein the first diode and the second diode are substantially different in size.

2. The LCOS integrated circuit of claim 1, wherein the temperature sensor is set at a position adjacent to a liquid crystal layer.

3. The LCOS integrated circuit of claim 1, wherein the temperature sensor is set at a position under a liquid crystal layer.

4. An electronic device, comprising:
a temperature sensor embedded in a liquid crystal display for sensing a temperature and outputting a temperature sensing signal according to the temperature, wherein the temperature sensor comprises:
a supply independent current circuit, providing first/second/third currents such that the first/second/third currents have same current value;
a first diode, coupled between the supply independent current circuit and a predetermined voltage such that the first current flows through the first diode;
a first resistor, one end of the first resistor coupled to the supply independent current circuit for receiving the second current;
a second diode, coupled between another end of the first resistor and the predetermined voltage such that the second current flows through the second diode; and
a second resistor, coupled between the supply independent current circuit and the predetermined voltage for receiving the third current, wherein the temperature sensing signal is generated at a point on a conducting path for coupling the supply independent current circuit and the second resistor and the first diode and the second diode are substantially different in size; and
a processor, coupled to the liquid crystal display for receiving the temperature sensing signal and outputting a cooler control signal according to the temperature sensing signal.

5. The electronic device of claim 4, wherein the processor further outputting a gamma control signal to the liquid crystal display for adjusting a gamma curve of a liquid crystal of the electronic device.

6. The electronic device of claim 4, wherein the processor further adjusting an R-V curve of a liquid crystal according to the received temperature sensing signal.

7. The electronic device of claim 4, wherein the temperature sensor is set at a position adjacent to a liquid crystal layer.

8. The electronic device of claim 4, wherein the temperature sensor is set at a position under a liquid crystal layer.

9. The electronic device of claim 4, further comprising a cooler, coupled to the processor for receiving the cooler control signal and adjusting the cooler according to the cooler control signal.

10. A temperature sensor for sensing a temperature and outputting a temperature sensing signal according to the temperature, comprising:
a supply independent current circuit, providing first/second/third currents such that the first/second/third currents have same current value;
a first diode, coupled between the supply independent current circuit and a predetermined voltage such that the first current flows through the first diode;
a first resistor, one end of the first resistor coupled to the supply independent current circuit for receiving the second current;
a second diode, coupled between another end of the first resistor and the predetermined voltage such that the second current flows through the second diode; and
a second resistor, coupled between the supply independent current circuit and the predetermined voltage for receiving the third current, wherein the temperature sensing signal is generated at a point on a conducting path for coupling the supply independent current circuit and the second resistor,
wherein the first diode and the second diode are substantially different in size.
